(19) United States
(12) Patent Application Publication
(10) Pub. No.: US 2006/0285550 A1
(43) Pub. Date: Dec. 21, 2006

(54) Apparatus, system, and method for communicating over multiple paths

(76) Inventors: Cam-Thuy Do, Sunnyvale, CA (US); Visbal Vijay Ghosalkar, San Jose, CA (US); Wenhua Liu, Sunnyvale, CA (US); Tariq Mustafa, Fremont, CA (US); Khoa Khon Ngo, San Jose, CA (US)

Correspondence Address: KUNZLER & ASSOCIATES, 8 EAST BROADWAY, SUITE 600, SALT LAKE CITY, UT, 84111, US

(21) Appl. No.: 11/154,172

(22) Filed: Jun. 16, 2005

(51) Int. Cl. H04L 12/26; H04B 7/212

(52) U.S. Cl. 370/443; 370/230

(57) ABSTRACT

An apparatus, system, and method are disclosed for communicating over multiple paths. A reserve interception module intercepts a single-path reserve command from a host. The host-computing environment is configured to issue single-path commands, but is not configured to issue multiple-path commands. A reserve generation module generates a multiple-path reserve command in response to the single-path command. A reserve command module reserves multiple paths between the host and the storage device using the multiple-path command, enabling the host to communicate over multiple paths with the storage device.

### FIELD OF THE INVENTION

This invention relates to communicating over multiple paths and more particularly relates to allowing a host configured to communicate over single paths to communicate over multiple paths.

### DESCRIPTION OF THE RELATED ART

Host computer systems or hosts such as mainframe computers, servers, workstations, and the like frequently access discrete storage devices such as hard disk drives, optical storage drives, magnetic tape drives, and solid-state storage devices. The host maybe configured to communicate with the storage device over a path such as a small computer system interface (“SCSI”), Fibre Channel, and universal serial bus (“USB”). Often the host or the host operating system environment is configured to communicate with the storage device over a single path. For example, an operating environment such as a Microsoft® Windows 2000® or Microsoft Windows 2003® cluster environment may be specifically configured to use a single SCSI-2 path to communicate with a storage device.

Some single paths such as a SCSI-2 path are configured with a standby path in addition to the principle traffic-bearing or traffic path. In many configurations, the standby path only carries data if the traffic path fails, particularly if the host is configured to communicate over single paths. For example, a host supporting a SCSI-2 path interface only communicates over a single traffic path although a standby path is also available.

Unfortunately, a single path is often insufficient to carry the required volume of data between the host and the storage device. As a result, many storage devices and paths have been configured to operate with multiple paths between a storage device and a host. For example, a storage device may use multiple paths configured as SCSI-3 paths. Using multiple paths can significantly increase the data volume transferred between the host and the storage device.

Unfortunately, many host-computing environments only support single path communications with storage devices. As a result, a host may be limited to single path communications although the storage device and storage device paths may support multiple paths.

From the foregoing discussion, it should be apparent that a need exists for an apparatus, system, and method that communicate over multiple paths from a host that natively supports only single path communications to a storage device. Beneficially, such an apparatus, system, and method would increase the volume of data transferred between the host and the storage device.

### SUMMARY OF THE INVENTION

The present invention has been developed in response to the present state of the art, and in particular, in response to the problems and needs in the art that have not yet been fully solved by currently available multiple path communication methods. Accordingly, the present invention has been developed to provide an apparatus, system, and method for communicating over multiple paths that overcome many or all of the above-discussed shortcomings in the art.

The apparatus to communicate over multiple paths is provided with a logic unit containing a plurality of modules configured to functionally execute the necessary steps of intercepting a single-path reserve command, generating a multiple-path reserve command, and reserving multiple paths. These modules in the described embodiments include a reserve interception module, a reserve generation module, and a reserve command module.

The reserve interception module intercepts a single-path reserve command from a host. In a certain embodiment, the host is configured to issue single-path commands such as single-path reserve commands, but may not be configured to issue multiple-path commands such as multiple-path reserve commands. In one embodiment, the single-path commands are SCSI-2 commands. The single-path reserve command is configured to reserve a single path between the host and a storage device. Reserving the path allows the host to transfer data to and from the storage device through the path. The path may be a data communication channel such as a SCSI bus, a Fibre Channel bus, and the like.

The reserve generation module generates a multiple-path reserve command. The multiple-path reserve command is configured to reserves one or more paths between the host and the storage device. In a certain embodiment, the multiple-path reserve command is a SCSI-3 reserve command.

The reserve generation module also generates a reservation key and includes the reservation key in the multiple-path reserve command. The storage device registers the path for transferring data between the host and the storage device using the reservation key. The host and the storage device use the reservation key to access the reserved path. In one embodiment, the reservation key may be generated from a time stamp.

The reserve command module reserves multiple paths from the host to the storage device. For example, the reserve command module may transmit the multiple-path reserve command to the storage device, registering one or more paths to the host and allowing the host to transfer data to and from the storage device through the paths. In one embodiment, the host and the host-computing environment only see a single path when communicating with the storage device.

In one embodiment, the apparatus further includes a communication module. The communication module may organize communication over multiple paths such that the host sees only a single path. For example, the communication module may assemble data transferred from the storage device over two paths such that the data appears to the host as coming from a single path. The apparatus enables communications over multiple paths for a host that supports single paths.

A system of the present invention is also presented to communicate over multiple paths. The system may be embodied in a computer network comprising one or more hosts and one or more storage devices. In particular, the system, in one embodiment, includes a storage device, a plurality of paths, and a host.

The host communicates with the storage device through one or more paths, transferring data to and receiving data from the storage device. The host-computing environment is configured to support single path data transfers, while the storage device and the paths are configured to support multiple path data transfers.

The host comprises a reserve interception module, a reserve generation module, and a reserve command module. The reserve interception module intercepts a single-path reserve command from a host. The reserve generation module generates a multiple-path reserve command. The reserve generation module reserves multiple paths between the host and the storage device using the multiple-path command. The system enables a host configured for single-path communication to transfer data over multiple paths, increasing the volume of data transferred.

A method of the present invention is also presented for communicating over multiple paths. The method in the disclosed embodiments substantially includes the steps necessary to carry out the functions presented above with respect to the operation of the described apparatus and system. In one embodiment, the method includes intercepting a single-path reserve command, generating a multiple-path reserve command, and reserving multiple paths.

A reserve interception module intercepts a single-path reserve command from a host. A reserve generation module generates a multiple-path reserve command. A reserve command module reserves multiple paths between the host and the storage device using the multiple-path command.

In one embodiment, a release interception module intercepts a single-path release command from the host to a storage device. The single-path release command releases the reservation for a single path. A release generation module generates a multiple-path release command from the intercepted single-path release command. A release command module releases all reservations of paths to the storage device.

In one embodiment, a reset interception module intercepts a single-path reset command from the host. A key acquisition module acquires the registration keys for the host and each path in communication with the host. A preemption module executes a preempt and abort process and clears the reserve for each path if the registration key for the path is not equal to the registration key for the host.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention enables a host configured to communicate with a storage device over a single path to communicate over multiple paths, increasing the volume of data transferred. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a multiple-path system in accordance with the present invention;

FIG. 2 is a schematic block diagram illustrating one embodiment of a multiple-path apparatus of the present invention;

FIG. 3 is a schematic block diagram illustrating one embodiment of a host of the present invention;

FIG. 4 is a schematic flow chart diagram illustrating one embodiment of a multiple-path communication method of the present invention; and

FIG. 5 is a schematic flow chart diagram illustrating one embodiment of a multiple-path release method of the present invention; and

FIG. 6 is a schematic flow chart diagram illustrating one embodiment of a multiple-path reset method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

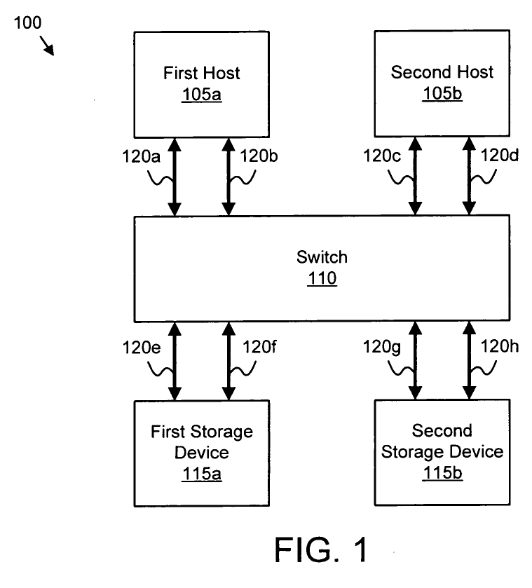

FIG. 1 is a schematic block diagram illustrating one embodiment of a multiple-path system 100 of the present invention. The system 100 includes one or more hosts 105, a switch 110, one or more storage devices 1 15, and one or more paths 120. Although for simplicity the system 100 is depicted with two hosts 105, one switch 110, two storage devices 115, and eight paths 120, any number of hosts 105, switches 110, storage devices 115, and paths 120 may be employed. Other devices may also be connected too the system 100.

The host 105 communicates with the storage device 115 through one or more paths 120, transferring data to and receiving data from the storage device 115. In the depicted embodiment, a first host 105a may communicate over a first path 120a with the switch 110 and the switch 110 communicates directly with a first storage device 115a over a fifth path 120e, although communications through the switch 110 are considered communications through a single path 120. In an alternate embodiment, the host 105 communicates directly with the storage device 115.

The host 105 includes a host-computing environment such as an operating system or the like. The host-computing environment is configured to support single path data transfers. Thus although a plurality of paths 120 are available for communication between the host 105 and the switch 110 and the switch 110 and the storage device 1 5, in the past the host 105 has been limited to communicating with the storage device 115 over single paths 120.

For example, the host-computing environment may limit the first host 125a to communicating with the first storage device 115a through the first path 120a, the switch 110, and the fifth path 120e. However, the storage devices 115 and the paths 120 are configured to support multiple path data transfers such as from the first host 105a through the first and second paths 120a, 120b, the switch 110, and the fifth and sixth paths 120e, 120f.

The system 100 allows the host 105 to communicate with the storage device 115 through multiple paths 120 although the host-computing environment only supports single path communication by intercepting single-path commands, generating multiple-path commands, and issuing the multiple path command. For example, the host 105 may intercept a single-path reserve command, generate a multiple-path reserve command, and reserve one or more paths 120 from the host 105 to the storage device 115 using the multiple-path reserve command.

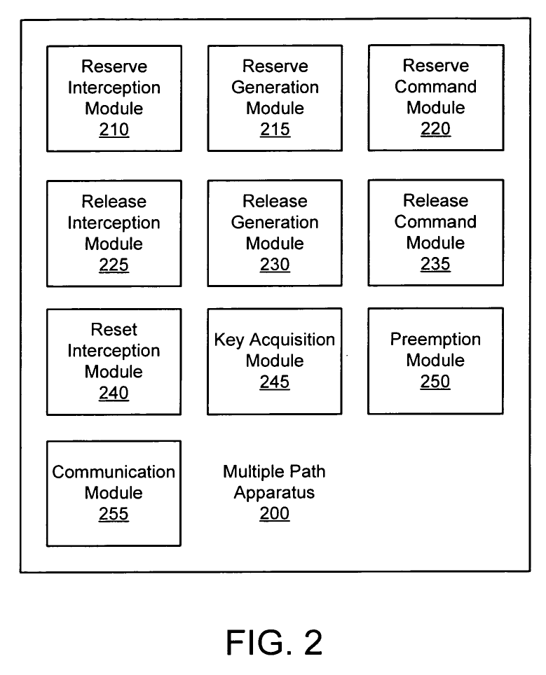

FIG. 2 is a schematic block diagram illustrating one embodiment of a multiple path apparatus 200 of the present invention. The host 105 of FIG. 1 may comprise the apparatus 200. As depicted, the apparatus 200 includes a reserve interception module 210, a reserve generation module 215, a reserve command module 220, a release interception module 225, a release generation module 230, a release command module 235, a reset interception module 240, a key acquisition module 245, a preemption module 250, and a communication module 255.

The reserve interception module 210 intercepts a single-path reserve command from a host 105. The host 105 includes a host computing environment configured to issue single-path commands such as the single-path reserve command, but not configured to issue multiple-path commands such as a multiple-path reserve command. In one embodiment, the single-path commands are SCSI-2 commands and the single-path reserve command is a SCSI-2 reserve command. The single-path reserve command is configured to reserve a single path 120 between the host 105 and a storage device 115. Reserving the path 115 allows the host 105 to transfer data to and from the storage device 115 through the path 120. The path 120 may be a data communication channel such as a SCSI bus, a Fibre Channel bus, and the like.

The reserve generation module 215 generates a multiple-path reserve command. The multiple-path reserve command is configured to reserve one or more paths 120 between the host 105 and the storage device 115. In a certain embodiment, the multiple-path reserve command is a SCSI-3 reserve command.

The reserve generation module 215 also generates a reservation key and includes the reservation key in the multiple-path reserve command. The storage device 115 registers the path 120 for transferring data between the host 105 and the storage device 115 using the reservation key. The host 105 also uses the reservation key to access the reserved path 115. In one embodiment, the reservation key may be generated from a time stamp.

The reserve command module 220 reserves multiple paths 120 from the host 105 to the storage device 115. In one embodiment, the reserve command module 220 transmits the multiple-path reserve command to the storage device 115. The storage device 115 registers one or more paths 120 to the host 105. The host 105 may transfer data to and from the storage device 115 through the registered paths 120.

In one embodiment, the communication module 255 organizes communication over the multiple paths 120 such that the host 105 and the host-operating environment see only a single path 120. For example, the communication module 255 may assemble data transferred from the storage device 115 over two paths 120 such that the data appears to the host 105 as coming from a single path 120. The communication module 255 may also divide data destined for the storage device 115 between two paths 120 and communicate the divided data over the two paths 120.

In one embodiment, the release interception module 225 intercepts a single-path release command from the host 105 to the storage device 115. The single-path release command releases the reservation for a single path 120. For example, the single-path release command may release a path 120 registered to a first host 105a by a storage device 115, allowing a second host 105b to reserve the path 120. The host 105 may issue the single-path release command because the host 105 and the host-computing environment are configured to communicate over single paths 120 and see all communications with the storage device 115 as over a single path 120.

The reserve command module 220 has reserved multiple paths from the host 105 to the storage device 115. Therefore the release interception module 225 intercepts the single-path release command and the release generation module 230 generates a multiple-path release command from the intercepted single-path release command. The release command module 235 releases all reservations of the multiple paths 120 to the storage device 115.

In one embodiment, the reset interception module 240 intercepts a single-path reset command from the host 115. The key acquisition module 245 acquires the registration keys for the host 105 and each path 120 in communication with the host 105. In one embodiment, the registration key for each path 120 is registered with the storage device 115. The preemption module 250 executes a preempt and abort process and clears the reservation for each path 120 if the registration key for the path 120 is not equal to the registration key for the host 105. The apparatus 200 enables communications over multiple paths 120 for a host 105 that supports single paths 120, reserving, releasing, and resetting the paths 120 in response to single-path commands from the host 105.

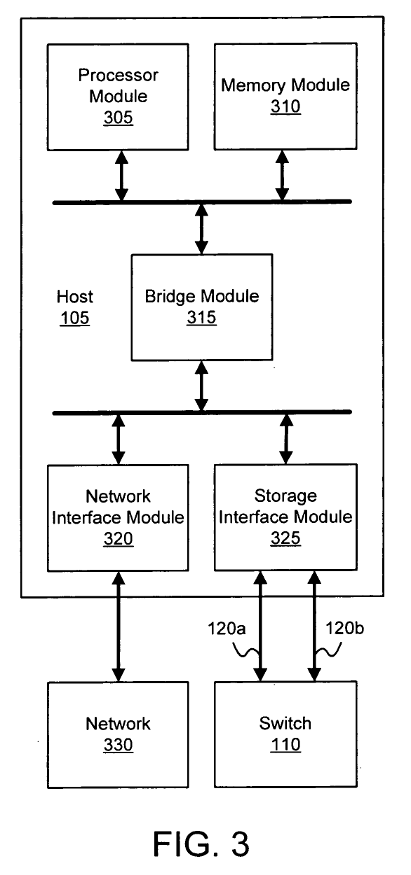

FIG. 3 is a schematic block diagram illustrating one embodiment of a host 105 of the present invention. The host 105 may be utilized as the host 105 of FIG. 1 and comprises the multiple path apparatus 200 of FIG. 2. The host 105 includes a processor module 305, a memory module 310, a bridge module 315, a network interface module 320, and a storage interface module 325. The host 105 is depicted in communication with a network 330 and switch 110.

The processor module 305, memory module 310, bridge module 315, network interface module 320, and storage interface module 325 maybe fabricated of semiconductor gates on one or more semiconductor substrates. Each semiconductor substrate may be packaged in one or more semiconductor devices mounted on circuit cards. Connections between the processor module 305, the memory module 310, the bridge module 315, the network interface module 320, and the storage interface module 325 may be through semiconductor metal layers, substrate to substrate wiring, or circuit card traces or wires connecting the semiconductor devices.

The memory module 310 stores software instructions and data. The processor module 305 executes the software instructions and manipulates the data as is well know to those skilled in the art. The software instructions and data may comprise a host-operating environment such as an operating system. In addition, the software instructions and data may comprise the reserve interception module 210, the reserve generation module 215, the reserve command module 220, the release interception module 225, the release generation module 230, the release command module 235, the reset interception module 240, the key acquisition module 245, the preemption module 250, and the communication module 255 depicted in FIG. 2.

In one embodiment, the processor module 305 executes a driver comprising the reserve interception module 210, the reserve generation module 215, the reserve command module 220, the release interception module 225, the release generation module 230, the release command module 235, the reset interception module 240, the key acquisition module 245, the preemption module 250, and the communication module 255. The driver is configured to enable the host 105 to communicate over multiple paths 120 where the host 105 and host-computing environment are configured to communicate over a single path 120.

In one embodiment, the processor module 305 communicates with the network interface module 320 and the storage interface module 325 through the bridge module 415. The processor module 305 executing the driver directs the storage interface module 325 to communicate with the switch 110 through multiple paths 120 although the host-operating environment executing on the processor module 305 may only see communication through a single path 120.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

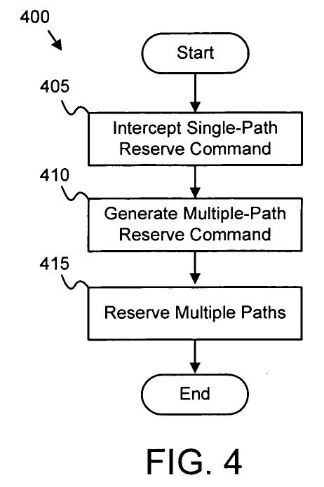

FIG. 4 is a schematic flow chart diagram illustrating one embodiment of a multiple-path communication method 400 of the present invention. The method 400 substantially includes the steps necessary to carry out the functions presented above with respect to the operation of the described system 100 in FIG. 1, the apparatus 200 in FIG. 2, and the host 105 in FIG. 3.

The method 400 begins and a reserve interception module 210 intercepts 405 a single-path reserve command from a host 105 to a storage device 115. In one embodiment, a driver configured to communicate with the storage device 115 for the host 105 and a host-operating environment comprises the reserve interception module 210. The host-operating environment may direct all commands, requests, and data for the storage device 115 and storage device paths 120 through the driver. In one embodiment, the reserve interception module 210 intercepts 405 the single-path reserve command by recognizing the single-path reserve command communicated to the driver and further directing that the single-path reserve command be processed rather than communicated directly to the storage device 115.

A reserve generation module 215 generates 410 a multiple-path reserve command. The driver may also comprise the reserve generation module 215. In one embodiment, the reserve generation module 215 generates 410 the multiple-path reserve command using an algorithm that translates the single-path reserve command to the corresponding multiple-path reserve command. In addition, the algorithm may translate one or more parameters of the single-path reserve command to one or more corresponding parameters of the multiple-path command. The reserve generation module 215 may also create one or more parameters including a reservation key for the multiple-path reserve command.

In one example, the reserve generation module 215 generates 410 a SCSI-3 persistent reserve command in response to a SCSI-2 reserve command. In addition, the reserve generation module 215 may generate 410 a reservation key from a time stamp and include the reservation key with the persistent reserve command.

A reserve command module 220 reserves 415 one or more paths between the host 105 and the storage device 115 using the multiple-path command. In one embodiment, the driver comprises the reserve command module 220. The reserve command module 220 may issue the multiple-path reserve command to the storage device 115, directing the storage device 115 to reserve one or more paths 120 to the host 105. The method 400 enables the host-computing environment configured for single-path communication to communicate with the storage device 115 over multiple paths 120 by reserving multiple paths 120.

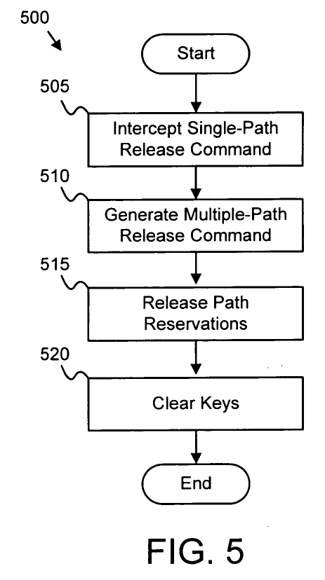

FIG. 5 is a schematic flow chart diagram illustrating one embodiment of a multiple-path release method 500 of the present invention. The method 500 substantially includes the steps necessary to carry out the release functions presented above with respect to the operation of the described apparatus 200 in FIG. 2 and the host 105 in FIG. 3.

In one embodiment, the method 500 begins and a release interception module 225 intercepts 505 a single-path release command from a host 105 to a storage device 115. A driver configured to communicate with a storage device 115 for the host 105 and a host-operating environment may comprise the release interception module 225. The host-operating environment may direct all commands, requests, and data for the storage device 115 and storage device paths 120 through the driver.

The single-path release command is configured to release the reservation of the host 105 for a single path 120. In one embodiment, the release interception module 225 intercepts 505 the single-path release command by recognizing the single-path release command communicated to the driver and further directing that the single-path release command be processed rather than communicated directly to the storage device 115.

A release generation module 230 generates 510 a multiple-path release command from the intercepted single-path release command. The driver may also comprise the release generation module 230. In one embodiment, the release generation module 230 generates 510 the multiple-path release command using an algorithm that translates the single-path release command to the corresponding multiple-path release command. In addition, the algorithm may translate one or more parameters of the single-path release command to one or more corresponding parameters of the multiple-path release command. For example, the release generation module 230 may generate 510 a SCSI-3 release command from a SCSI-2 release command.

A release command module 235 releases 515 all reservations of paths 120 to the storage device 115 by issuing the multiple-path release command to the storage device 115. The storage device 115 releases all path 120 reservations responsive to the command. The driver may comprise the release command module 235. In one embodiment, the release command module 235 further clears 520 one or more reservation keys of the storage device 115. For example, the release command module 235 may direct the storage device 115 to clear the reservation key for each path 120 in communication with the storage device 115. The method 500 enables the host-computing environment configured for single-path communication to communicate with the storage device 115 over multiple paths 120 by releasing multiple paths 120 in response to the host computing environment's single-path release command.

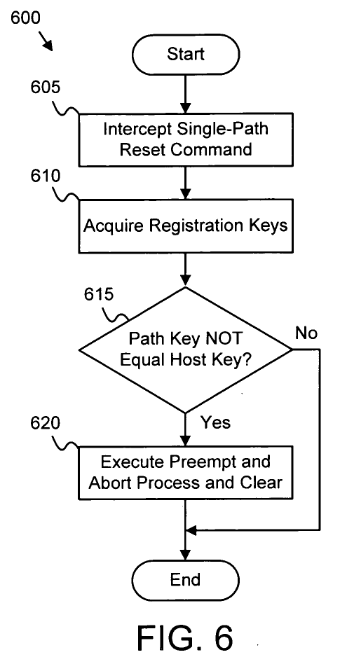

FIG. 6 is a schematic flow chart diagram illustrating one embodiment of a multiple-path reset method 600 of the present invention. The method 600 substantially includes the steps necessary to carry out the reset functions presented above with respect to the operation of the described apparatus 200 in FIG. 2 and the host 105 in FIG. 3.

In one embodiment, the method begins and a reset interception module 240 intercepts 605 a single-path reset command from a host 105. The single-path reset command resets each path 120 in communication with the host 105. In one embodiment, a driver configured to communicate with the storage device 115 for the host 105 and a host-operating environment comprises the reset interception module 240. The host-operating environment may direct all commands, requests, and data for the storage device 115 and storage device paths 120 through the driver. In one embodiment, the reset interception module 240 intercepts 605 the single-path reserve command by recognizing the single-path reset command communicated to the driver and directing that the single-path reset command be processed rather than communicated directly to the storage device 115.

A key acquisition module 245 acquires 610 the registration keys for the host 105 and the path 120. The driver may also comprise the key acquisition module 245. The key acquisition module 245 may acquire 610 the host 105 registration key from the driver. In addition, the key acquisition module 245 may acquire 610 the registration key for each path 120 in communication with the host 105 by querying each storage device 115 in communication with the host 105. Each storage device 115 may respond with the registration keys for the paths 120.

A preemption module 250 determines 615 if the registration key for each path 120 is equal to the registration key for the host 105. If the path 120 registration key and the host 105 registration key are equal, the method 600 ends. If the path 120 registration key and the host 105 registration key are not equal, the preemption module 250 executes 620 a multiple-path preempt and abort process directed to the path 120 and clears the reserve for the path 120. Clearing the reserve for the path 120 enables a host 105 to reserve the path 120. The method 600 enables the host computing environment configured for single-path communication to communicate with the storage device 115 over multiple paths 120 by resetting one or more paths 120 in response to the host computing environment's single-path reset command.

The present invention enables a host 105 configured to communicate with a storage device 115 over a single path 120 to communicate over multiple paths 120, increasing the volume of data transferred. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to communicate over multiple paths, the apparatus: comprising:
a reserve interception module configured to intercept a single-path reserve command from a host;
a reserve generation module configured to generate a multiple-path reserve command comprising a reservation key; and
a reserve command module configured to reserve multiple paths from the host to a storage device using the multiple-path reserve command, wherein the host and each path receives the reservation key.

2. The apparatus of claim 1, further comprising a release interception module configured to intercept a single-path release command from the host, a release generation module configured to generate a multiple-path release command, and a release command module configured to release all reservations of paths to the storage device.

3. The apparatus of claim 2, wherein the release command module is further configured to clear the path reservation keys.

4. The apparatus of claim 1, further comprising a reset interception module configured to intercept a single-path reset command from the host, a key acquisition module configured to acquire the registration keys for the host and the path in communication with the host, and a preemption module configured to execute a preempt and abort process and clear the reserve for the path if the registration key for the path is not equal to the registration key for the host.

5. The apparatus of claim 1, wherein the single-path commands are configured as SCSI-2 commands.

6. The apparatus of claim 1, wherein the multiple-path commands are configured as SCSI-3 commands.

7. The apparatus of claim 1, wherein the host and the storage device are operating in a cluster environment.

8. A system to communicate over multiple paths, the system comprising:
a storage device configured to store and retrieve data;
a plurality of paths; and
a host in communication with the storage device through at least one path and comprising
a reserve interception module configured to intercept a single-path reserve command from the host;
a reserve generation module configured to generate a multiple-path reserve command comprising a reservation key; and
a reserve command module configured to reserve multiple paths from the host to the storage device using the multiple-path reserve command, wherein the host and each path receives the reservation key.

9. The system of claim 8, further comprising a release interception module configured to intercept a single-path release command from the host, a release generation module configured to generate a multiple-path release command, and a release command module configured to release all reservations of paths to the storage device and to clear the path reservation keys.

10. The system of claim 8, further comprising a reset interception module configured to intercept a single-path reset command from the host, a key acquisition module configured to acquire the registration keys for the host and the path in communication with the host, and a preemption module configured to execute a preempt and abort process and clear the reserve for the path if the registration key for the path is not equal to the registration key for the host.

11. The system of claim 8, wherein the single-path commands are configured as SCSI-2 commands.

12. The system of claim 8, wherein the multiple-path commands are configured as SCSI-3 commands.

13. The system of claim 8, wherein the host and the storage device are operating in a cluster environment.

14. A signal bearing medium tangibly embodying a program of machine-readable instructions executable by a digital processing apparatus to perform operations to communicate over multiple paths, the operations comprising:
intercepting a single-path reserve command from a host;
generating a multiple-path reserve command comprising a reservation key; and
reserving multiple paths from the host to a storage device using the multiple-path reserve command, wherein the host and each path receives the reservation key.

15. The signal bearing medium of claim 14, wherein the instructions further comprise operations to intercept a single-path release command from the host, generate a multiple-path release command, and release all reservations of paths to the storage device.

16. The signal bearing medium of claim 15, wherein the instructions further comprise operations to clear the path reservation keys.

17. The signal bearing medium of claim 14, wherein the instructions further comprise operations to intercept a single-path reset command from the host, acquire the registration keys for the host and the path in communication with the host, and execute a preempt and abort process and clear the reserve for the path if the registration key for the path is not equal to the registration key for the host.

18. The signal bearing medium of claim 14, wherein the single-path commands are configured as SCSI-2 commands.

19. The signal bearing medium of claim 14, wherein the multiple-path commands are configured as SCSI-3 commands.

20. The signal bearing medium of claim 14, wherein the host and the storage device are operating in a cluster environment.
